(19) United States
(12) Patent Application Publication
(10) Pub. No.: US 2022/0232785 A1
(43) Pub. Date: Jul. 28, 2022

(54) AEROPONIC SYSTEMS AND COMPONENTS

(71) Applicant: PROTERA AG, INC., Commerce, PA (US)

(72) Inventors: Morris Gasmer, Whittier, CA (US); Kristopher Rusell, Whittier, CA (US)

(21) Appl. No.: 17/617,571

(22) PCT Filed: May 14, 2020
(86) PCT No.: PCT/US2020/032934

§ 371 Date: Dec. 8, 2021

Related U.S. Application Data
(60) Provisional application No. 62/847,835, filed on May 14, 2019.

(51) Int. Cl. A01G 31/02

(52) U.S. Cl. CPC A01G 31/02

(57) ABSTRACT

An aeroponic crop growing system may include a plurality of vertical walls configured to grow plants extending through the walls. Drains may allow for drainage of excess water, with the drains providing the excess water to gutters. In some embodiments the gutters are positioned below a floor under the walls, with the floor including gaps for passage of the water from the drains of the walls to the gutters. In some embodiments the gaps in the floor, gutters, and walls may be repositionable. In some embodiments the floor may be of modular components, which may allow for drainage of excess liquid for a variety of different grow wall configurations.

### BACKGROUND OF THE INVENTION

The present invention(s) relate generally to aeroponic crop growing systems, and more particularly to vertical wall aeroponic crop growing systems.

Aqueously grown crops generally maintain roots of the crops in an aqueous rich environment, with the roots either in a liquid solution or a mist environment. For example, hydroponically grown crops generally maintain roots of the crops in a liquid solution of water and nutrients. Also for example, aeroponically grown crops generally maintain roots of the crops in an aqueous mist environment, with the mist formed using a liquid solution, and the mist providing water and nutrients for plant growth. The mist may be provided, for example, using micron sized nozzles.

Some aeroponic systems may grow crops on generally vertical walls. In such instances, a canopy of the plants may face lighting outside a front face of the wall, with roots of the plants in a mist environment in a volume to a rear of the wall. The volume of the rear of the wall may be generally enclosed, for example to allow for maintenance of the mist environment.

Unfortunately, the enclosure of the mist environment may present problems in accessing the nozzles used in creating the mist environment, and the nozzles may require maintenance from time to time. Similarly, connection of water to the nozzles may be laborious, as may be reconfiguring layout of the walls, reducing desirability of use of a vertical wall aeroponics system. Further complicating matters, connections for drainage of the excess water from the mist environment may also pose difficulties.

### BRIEF SUMMARY OF THE INVENTION

An aeroponic crop growing system may include a plurality of vertical walls configured to grow plants extending through the walls. The walls may include drains for drainage of excess water, with the drains providing the excess water to gutters. In some embodiments the gutters are positioned below a floor under the walls, with the floor including gaps for passage of the water from the drains of the walls to the gutters. In some embodiments the gaps in the floor, gutters, and walls may be repositionable, so as to allow for different configurations for the walls, for example in a room or container. In some embodiments structures providing for the drains also provide conduits for provision of liquid to piping with nozzles, for use in providing a mist environment for the plants.

Some embodiments provide a grow system with modular flooring, comprising: a grow container; a plurality of grow walls for aeroponically growing plants within the grow container, each grow wall comprising a face for receiving plants and an interior for enclosing a mist environment; a plurality of horizontal panels forming a floor in the grow container, below a level of a bottom of the grow walls, with gaps between the horizontal panels under the bottom of the grow walls; a plurality of liquid flow connectors, one of each at a bottom of the grow walls, and each including a trough with an open bottom under each of the gaps between the horizontal panels under the bottom of the grow walls; and a plurality of drainage gutters, one of each below the open bottom of the troughs.

Some embodiments provide a grow wall for an aeroponics plant growth system, including a liquid in-flow, outflow connector, comprising: the grow wall provided by a chassis outlining a hollow rectangular shape and wall faces mounted on opposing sides of the chassis, with the chassis and wall face substantially enclosing a rectangular volume; a connector providing a bottom of the grow wall, the connector comprising a member with a longitudinal length with opposing parallel beams across a top of the connector and an open bottomed trough separating the connectors; with each of the beams of the connectors including conduits passing lengthwise through the beams.

Some embodiments provide a grow wall for an aeroponics grow system, comprising: a chassis outlining a substantially hollow rectangular shape; walls mounted on opposing sides of the chassis, with the walls including circumferential flanges about tops and sides of the walls, with the flanges fitting over edges of the chassis; and hinges coupling coupling one side of the walls to the chassis to allow for access to an interior of the substantially rectangular shape.

These and other aspects of the invention are more fully comprehended upon review of this disclosure.

### BRIEF DESCRIPTION OF THE FIGURES

FIG. 1 is a perspective view of aspects of a vertical wall aeroponic plant growth system.

FIG. 2 is a perspective front view of a container for a vertical wall aeroponic growth system.

FIG. 3 is a perspective view of a double sided grow wall in accordance with aspects of the invention.

FIG. 4 is a perspective view of the grow wall of FIG. 3 with a face of one wall in a partly open position.

FIG. 5 is a perspective view of a frame of a chassis for a grow wall, in accordance with aspects of the invention.

FIG. 6 is a perspective view of a liquid in-flow, out-flow connector for a grow wall, in accordance with aspects of the invention.

FIG. 7 is a perspective view of piping for a grow wall, in accordance with aspects of the invention.

FIG. 8 includes a diagrammatic cross-sectional view of the liquid in-flow, outflow connector of FIG. 6.

FIG. 9 illustrates a front view of a portion of a container for a vertical wall aeroponic growth system with repositionable drainage gutters, in accordance with aspects of the invention.

FIG. 10 illustrates a front view of the container for a vertical wall aeroponic growth system of FIG. 9, with a modular floor in accordance with aspects of the invention.

FIGS. 11A-C illustrate portions of an installation sequence for the repositionable drainage gutters and modular floor.

FIGS. 12A-C illustrate different configurations of grow walls in a container making use of the repositionable drainage gutters and modular floor, in accordance with aspects of the invention.

### DETAILED DESCRIPTION

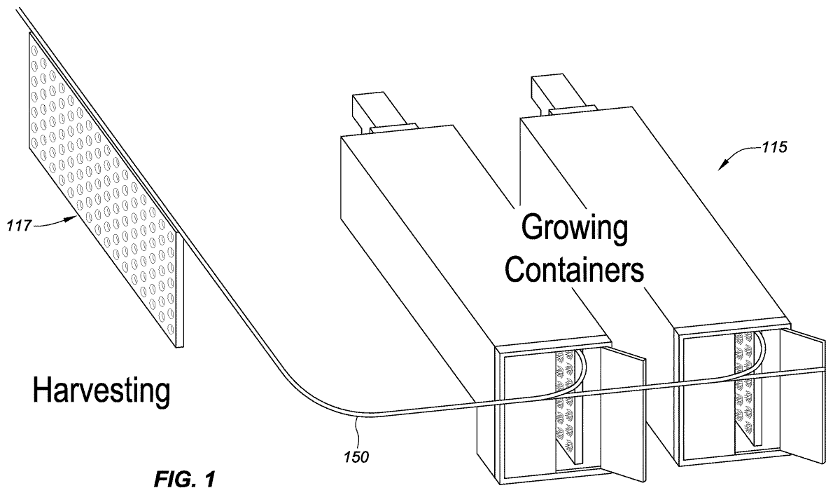

FIG. 1 illustrates a portion of large scale aeroponic farm that is representative of an aqueous farm system in accordance with some embodiments of the invention. The large scale aeroponic farm includes growing containers 115, and a harvesting station 135. The growing containers may be, for example, in the form of a shipping container. Generally, a climate and/or aqueous circulation control systems (not shown) may be used in providing appropriate environmental conditions within the growing containers or parts thereof. As illustrated, the growing containers and harvesting station are connected by an overhead track system 150.

In FIG. 1, the plants are grown in grow walls, for example grow wall 117, that may be comprised of multiple grow panels. Generally, the plant canopies are on outer face(s) of the grow walls, with roots of the plants in a mist environment within the grow walls. In the embodiment of FIG. 1, each grow wall has one or more couplings that affix the grow wall to the track system. The track system may be used to move the grow walls from the growing containers to the harvesting station. After the plants in the growing containers have matured and are ready to be harvested, the grow wall is moved to the harvesting station.

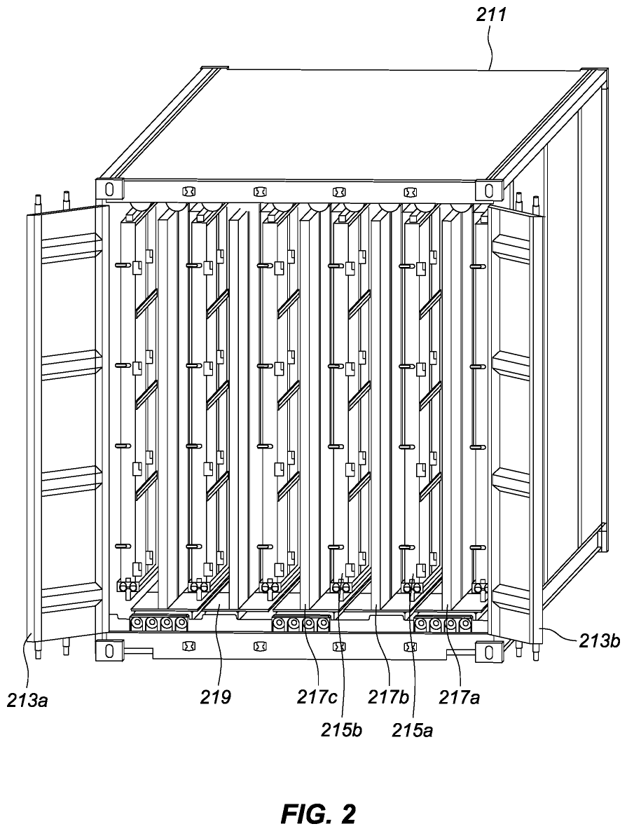

FIG. 2 is a perspective front view of a container 211 for a vertical wall aeroponic growth system. The container is generally in the form of a rectangular box, and may be a shipping container. The container includes doors 213a,b on one side, with each of the doors coupled to sidewalls of the container. FIG. 2 illustrates the doors in an open position, allowing a view into the container.

A plurality of grow walls, for example grow walls 215a-b are within the container. The grow walls extend lengthwise substantially a length of the container, from a side of the container with the doors to a rear wall of the container. The grow walls also extend vertically within the container, from close to a floor 219 of the container to close to a top wall of the container. For assisting in growth of plants in the grow walls, lighting panels, for example lighting panels 217a-c, are disposed between each of the grow walls, and in some embodiments between edge grow walls, nearest sidewalls of the container, and the sidewalls of the container.

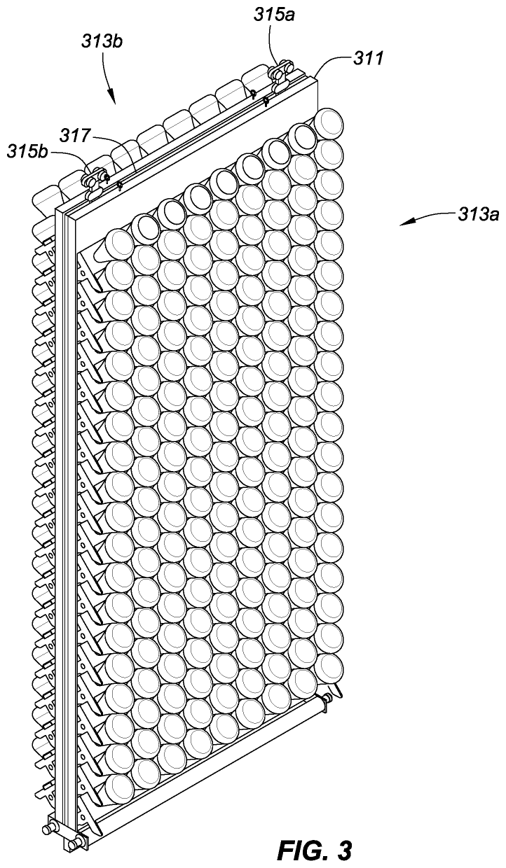

FIG. 3 is a perspective view of a double sided grow wall in accordance with aspects of the invention. The grow wall includes a chassis 311 outlining a substantially hollow rectangular shape. Wall faces 313a,b, also substantially rectangular in shape with edges of similar length to that of the chassis, are mounted on opposing sides of the chassis. The wall faces and chassis together substantially enclose an interior volume of the grow wall. Rollers 315a,b are mounted to a top pane 317 of the chassis, allowing the grow wall to be hung from a track. In FIG. 3, the walls are shown as having representations of plant canopies extending outward from the wall faces, the canopies each having a bulb shape with the plants shown generally arranged in rows and columns on the wall faces. Roots of the plants extend into the interior volume of the grow wall.

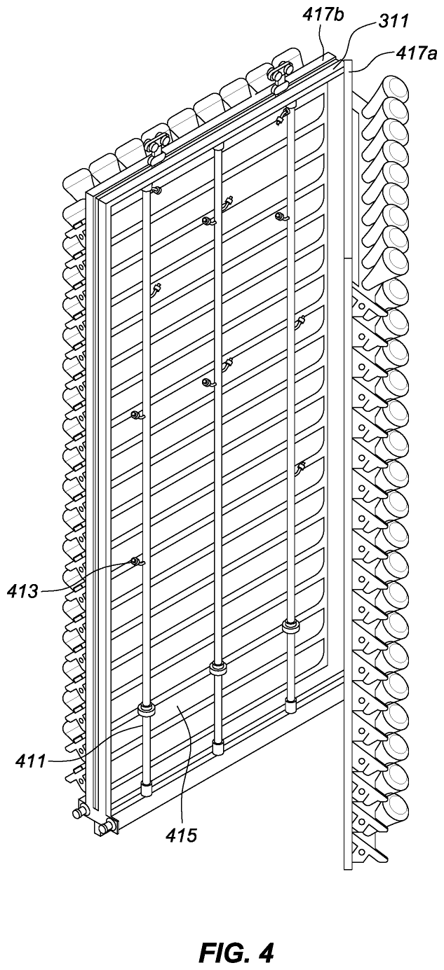

FIG. 4 is a perspective view of the grow wall of FIG. 3 with a face of one wall in a partly open position. With one wall partly open an interior surface 415 of the facing to the walls may be seen. In addition, piping, for example piping 411, for provision of liquid to the roots of plants may be seen within the interior volume of the grow wall. In FIG. 4, the piping includes 3 visible segments (connected by a top segment not visible in FIG. 4). Nozzles, for example nozzle 411, are coupled to the piping. The nozzles may be micron sized nozzles, for providing a mist environment, from liquid in the piping, within the interior volume.

As may be seen in FIG. 4, the walls include circumferential flanges 417a,b about the top and the sides of the faces of the walls, with the flanges fitting over edges of the chassis 311. Hinges couple the faces of the walls wall and the chassis, along the circumference of one side of the faces, allowing the faces to swing open and provide access to the interior volume of the wall.

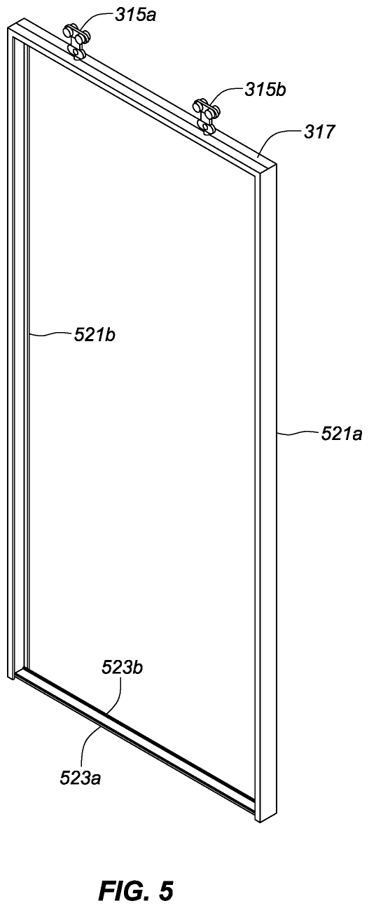

FIG. 5 is a perspective view of a frame of a chassis for a grow wall, in accordance with aspects of the invention. The chassis provides a substantially rectangular frame, with a top surface 317 coupled by side surfaces 521a,b to a pair of parallel bars 523a,b forming a bottom side of the chassis. Rollers 315a,b are coupled to the top surface, for example for hanging the chassis to a track. The bottom parallel bars includes a space between the bars, for example allowing piping to be introduced between the bars.

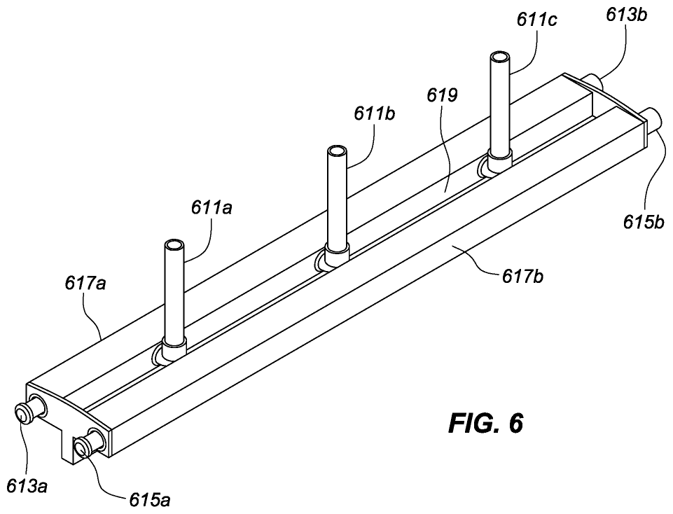

FIG. 6 is a perspective view of a liquid in-flow, out-flow connector for a grow wall, in accordance with aspects of the invention. In operation the connector is generally positioned directly underneath the grow wall, and in some embodiments may be considered to provide a bottom of the grow wall. The connector is generally a member with a longitudinal length and a somewhat T-shaped cross-section. Two opposing parallel hollow beams 617a,b run across a top of the length of the connector, with a trough 619 separating the beams.

The beams themselves have an upper surface with a slight inclination towards the trough. With the connector at the bottom of the grow walls, excess liquid from the mist in the interior volume of the grow wall may fall into the trough, or fall onto the inclined surfaces of the beams and then into the trough. The trough generally has an opening at its bottom, thereby forming a drain for the grow wall.

The beams also include conduits passing lengthwise through the beams. For example, beam 617a includes a conduit passing from a connection 613a on one lengthwise side of the beam 617a to a connection 613b on another lengthwise side of the beam. The connection 613a may be used to receive liquid from a supply, or from a connector of another grow wall. Similarly, the connection 613b may be coupled to a connector of another grow wall, or be capped if the connector is serving of a last grow wall in a chain of grow walls. In addition, the conduit includes connections to piping 611a and 611c for provision of liquid to the interior volume of the grow wall. The connections to the piping are shown as extending from the beam 617a into the trough. The piping 611a and 611c (and 611b) may be passed, for example, between the parallel bars of the bottom of the chassis of FIG. 5. Also, for example, beam 617b includes a conduit passing from a connection 615a on one lengthwise side of the beam 617b to a connection 615b on another lengthwise side of the beam, with the conduit including a connection to piping 611b. The piping 611b may be used as a return line for excess liquid provided by the piping 611a,c, with the conduit in the beam 617b also acting as such a return line. As with the conduit in the beam 617a, the conduit in beam 617b may be coupled to connectors of other grow walls in a chain of grow walls, providing a return path for excess supplied liquid.

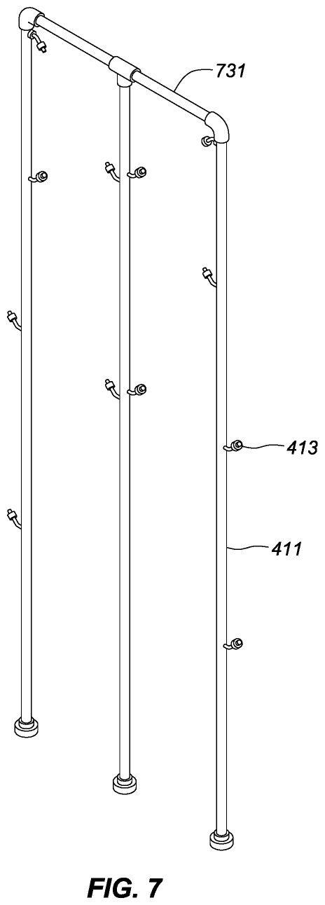

FIG. 7 is a perspective view of piping for a grow wall, in accordance with aspects of the invention. The piping includes vertical piping 411 that runs from a connector(s) at a bottom of a grow wall to a top pipe 731 that connects the vertical piping. Sprayers 413 for providing the mist environment may be distributed along the piping. In some embodiments, and as shown in FIG. 7, three parallel vertical pipes are used, linearly arranged. Of the three vertical pipes, the outer two pipes are coupled to a liquid supply line, with the middle pipe connected to a return line.

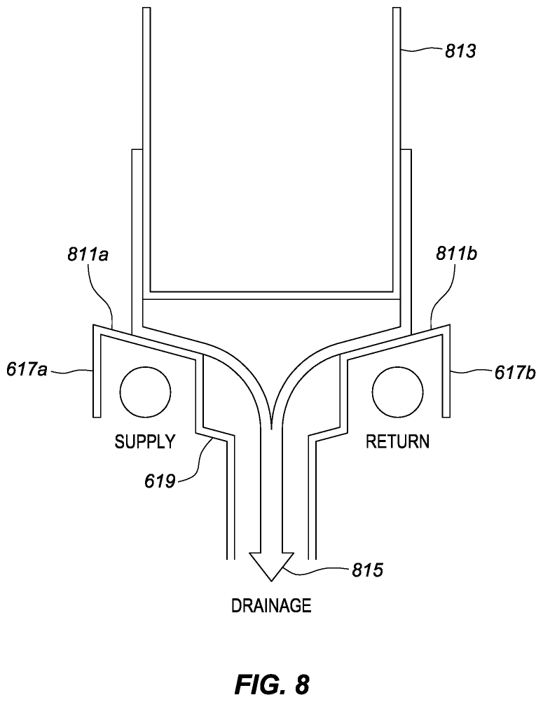

FIG. 8 includes a diagrammatic cross-sectional view of the liquid in-flow, outflow connector of FIG. 6. The cross-section shows the beams 617a,b bounding the trough 619. The beam 617a has an upper surface 811a with a downward inclination towards the trough, as does the upper surface 811b for the beam 617b. A bottom of the trough is shown as open, allowing for liquid to pass out of the trough. In some embodiments the opening extends substantially along the length of the trough, for example except for end caps for the trough. In other embodiments the trough may have one or more apertures in its bottom, allowing for drainage of liquid from the trough. The connector itself is shown as below a grow wall 813, with a space below the grow wall and the connector, and ends of the beams of the connector extending past outer faces of the grow wall. In some embodiments, however, the connector is directly below the grow wall, with the connector and grow wall in physical contact, and in some embodiments the connector provides a bottom surface of the grow wall.

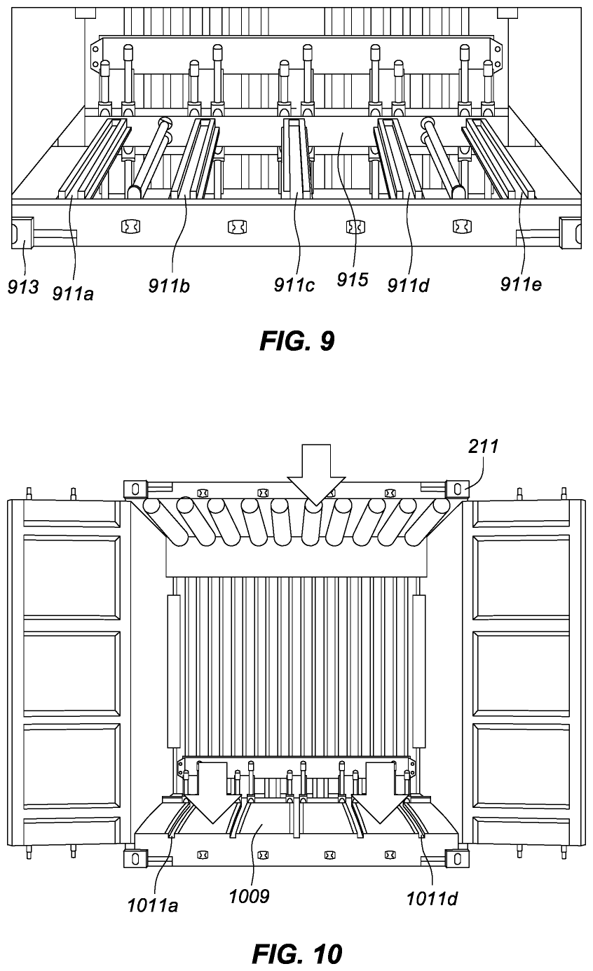

FIG. 9 illustrates a front view of a portion of a container for a vertical wall aeroponic growth system with repositionable drainage gutters 911a-e, in accordance with aspects of the invention. The drainage gutters are in a container, for example a bottom of the container, and provide for drainage of excess liquid from the grow walls. The drainage gutters extend substantially from a front 913 of the container to a rear of the container. The drainage gutters may be U-shaped, or some other shape that allows for collection of liquid. The drainage gutters may direct liquid to a sump, for example located at a back (or a front) of the container. In operation, the drainage gutters may be positioned under the connectors of FIG. 8. To allow for differing placement of grow walls, the drainage gutters may be positioned anywhere along a width of the container. Similarly, to allow for use of different numbers of grow walls, different numbers of gutters may be used.

Presence along a floor of the container may present difficulties, however. Accordingly, FIG. 10 illustrates a front view of the container for a vertical wall aeroponic growth system of FIG. 9, with a modular floor in accordance with aspects of the invention. The modular floor may be placed over the drainage gutters of FIG. 9. The modular floors include horizontal panels, for example horizontal panel 1009 extending from a front to a rear of the container 211. Gaps, for example gaps 1011a and 1011d, are between adjacent horizontal panels. The gaps may be positioned under grow walls, and over drainage gutters, allowing for drainage of excess fluid from the grow walls. In some embodiments the gaps are dimensioned to receive outlet troughs of bottoms of the grow walls, or connectors such as the connector of FIG. 8. In various embodiments panels of different widths may be used, to allow for increased diversity in spacing of grow walls within a container.

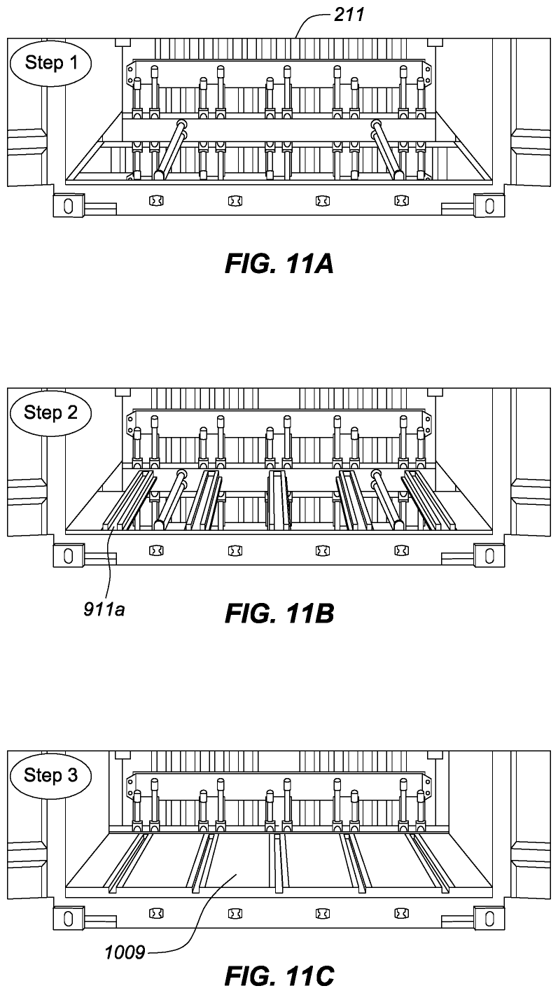

FIGS. 11A-C illustrate portions of an installation sequence for the repositionable drainage gutters and modular floor. FIG. 11A shows a container without drainage gutters or modular flooring. FIG. 11B shows drainage gutters, for example gutter 911a positioned from approximately a front to approximately a rear of the container. FIG. 11C shows the modular floor panels, for example panel 1009, placed in the container over the gutters.

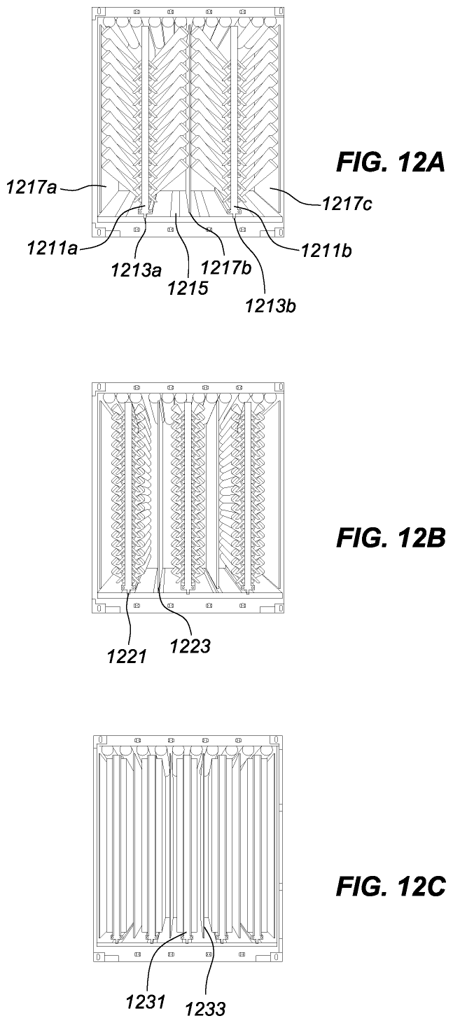

FIGS. 12A-C illustrate different configurations of grow walls in a container making use of the repositionable drainage gutters and modular floor, in accordance with aspects of the invention.

FIG. 12A shows two grow panels 1211a,b, which generally extend in parallel from approximately a front to approximately a rear of a container. Gaps 1213a,b are in a floor 1215, allowing for drainage of excess water from the grow panels to drainage gutters, for example. Lighting panels 1217a,b,c are also arranged in parallel with the grow walls, with one lighting panel 1217b between the grow walls, and lighting panels 1217a,c at opposing sides of the two grow walls.

FIG. 12B shows the use of three grow panels, for example including grow panel 1221, arranged as discussed with respect to FIG. 12A, but with different spacing. Lighting panels, for example lighting panel 1223, are similarly shown. Also similar to FIG. 12A, gaps are in the floor under the grow walls. As a further example, FIG. 12C shows the use of five grow panels, for example including grow panel 1231, arranged as discussed with respect to FIG. 12A, but again with different spacing. Lighting panels, for example lighting panel 1233, are similarly shown.

Although the invention has been discussed with respect to various embodiments, it should be recognized that the invention comprises the novel and non-obvious claims supported by this disclosure.

1. A grow system with modular flooring, comprising:
a grow container;
a plurality of grow walls for aeroponically growing plants within the grow container, each grow wall comprising a face for receiving plants and an interior for enclosing a mist environment;
a plurality of horizontal panels forming a floor in the grow container, below a level of a bottom of the grow walls, with gaps between the horizontal panels under the bottom of the grow walls;
a plurality of liquid flow connectors, one of each at a bottom of the grow walls, and each including a trough with an open bottom under each of the gaps between the horizontal panels under the bottom of the grow walls; and
a plurality of drainage gutters, one of each below the open bottom of the troughs.

2. The grow system with modular flooring of claim 1, wherein the plurality of grow walls and the plurality of drainage gutters are positionable at different locations within the grow container.

3. The grow system with modular flooring of claim 1, wherein each of the liquid flow containers includes parallel beams across a top of a length of the container, with the trough separating the beams.

4. The grow system with modular flooring of claim 3, wherein the beams have an upper surface with an inclination towards the trough.

5. The grow system with modular flooring of claim 4, wherein the beams include conduits passing lengthwise through the beams.

6. The grow system with modular flooring of claim 5, further comprising piping to supply liquid to the interior of the grow walls, and wherein the conduits include connections to the piping.

7. The grow system with modular flooring of claim 6, wherein the connections to the piping extend into the trough.

8. A grow wall for an aeroponics plant growth system, including a liquid in-flow, outflow connector, comprising:
the grow wall provided by a chassis outlining a hollow rectangular shape and wall faces mounted on opposing sides of the chassis, with the chassis and wall face substantially enclosing a rectangular volume;
a connector providing a bottom of the grow wall, the connector comprising a member with a longitudinal length with opposing parallel beams across a top of the connector and an open bottomed trough separating the connectors;
with each of the beams of the connectors including conduits passing lengthwise through the beams.

9. The grow wall of claim 8, wherein the conduits pass from a connection on one lengthwise side of the beams to a connection on another lengthwise side of the beams.

10. The grow wall of claim 9, wherein the conduits additionally include connections for provision of liquids to an interior of the rectangular volume.

11. The grow wall of claim 8, wherein the beams have an upper surface with an inclination towards the trough.

12. A grow wall for an aeroponics grow system, comprising:
a chassis outlining a substantially hollow rectangular shape;
walls mounted on opposing sides of the chassis, with the walls including circumferential flanges about tops and sides of the walls, with the flanges fitting over edges of the chassis; and
hinges coupling coupling one side of the walls to the chassis to allow for access to an interior of the substantially rectangular shape.
